(19) United States
(12) Patent Application Publication
(10) Pub. No.: US 2020/0108301 A1
(43) Pub. Date: Apr. 9, 2020

(54) Guide Mat and Method of Use

(71) Applicant: Korey K. Whitaker, Ogden, UT (US)

(72) Inventor: Korey K. Whitaker, Ogden, UT (US)

(21) Appl. No.: 16/706,771

(22) Filed: Dec. 8, 2019

Related U.S. Application Data
(60) Provisional application No. 62/777,148, filed on Dec. 8, 2018.

(51) Int. Cl. A63B 69/00; A01K 15/02

(52) U.S. Cl. CPC A63B 69/0068; A01K 15/02

(57) ABSTRACT

The present invention is a guide mat having guide indicia thereon for use in particular for guiding proper positioning of a person engaged in roping an animal, including heading (roping all or a portion of the head of the animal) and heeling (roping all or a portion of the rear legs of the animal). The guide may also be useful in properly positioning a participant in other sporting activities.

### CROSS REFERENCE TO RELATED APPLICATIONS

This nonprovisional utility patent application claims the benefit under 35 USC § 119(e) of U.S. provisional application No. 62/777,148, filed Dec. 8, 2018, which is incorporated herein, in its entirety, by this reference.

### FIELD OF THE INVENTION

The present invention relates to guides, and more especially to guides in the form a mat having guide indicia thereon for use is guiding proper position of a participant in a sporting activity.

### BACKGROUND OF THE INVENTION

Various position guides for various positioning purposes are known in the art. Further, roping dummies are known in the art. An example of such roping dummy is disclosed in the following US patent which is expressly incorporated herein by reference: U.S. Pat. No. 8,720,894 to Whitaker for “Ground Preparation Apparatus”.

### SUMMARY OF THE INVENTION

The present invention is a guide mat having guide indicia thereon for use in particular for guiding proper positioning of a person engaged in roping an animal, including heading (roping all or a portion of the head of the animal) and heeling (roping all or a portion of the rear legs of the animal). The guide may also be useful in properly positioning a participant in other sporting activities.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a plan view of a first embodiment of the invention;

FIG. 2 is a trimetric view of a first embodiment of the invention, and;

FIG. 3 is a plan view of a second embodiment of the invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature list is provided below. It is noted that like features are like numbered throughout all of the figures.

FEATURE TABLE

| # | Feature | # | Feature |
|---|---|---|---|
| 10 | Roping guide mat | 12 | Guide indicia |
| 14 | Target indicia | 20 | Roping dummy |
| 22 | Head | 24 | Horn |
| 26 | Rear | 28 | Hind legs |
| 30 | Baseball guide mat | 32 | Guide indicia |
| 34 | Target indicia | 36 | Footprint |

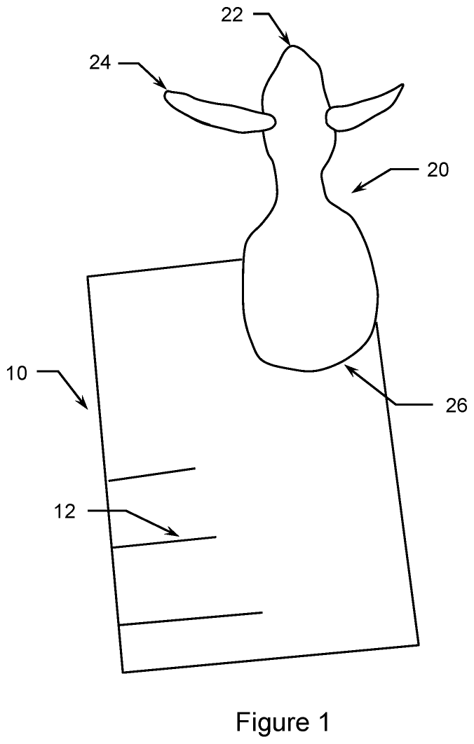

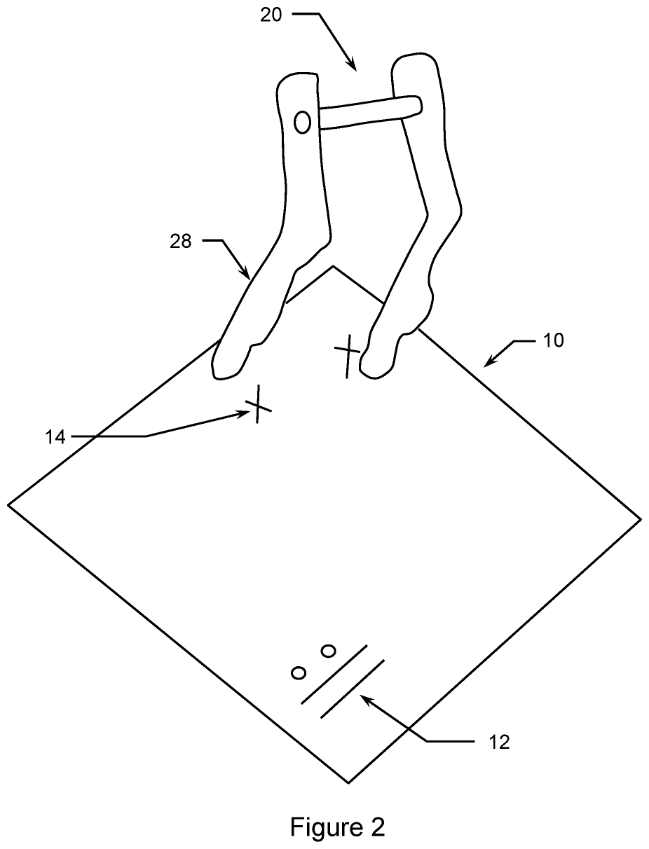

Referring now to the drawings and in particular to FIGS. 1 and 2, a first embodiment of the invention is a roping guide mat 10 having guide indicia 12 thereon adapted to promote the proper positioning of a roper in heading and/or heeling an animal such as a calf. Roping guide mat 10 preferably defines a mat such as a canvas or plastic mat having dimensions of approximately 4 feet by 6 feet (but may be larger or smaller than 4 feet by 6 feet) and having guide indicia 12 and target indicia 14 thereon. Guide indicia 12 may comprise one or more dots, circles, lines, footprints, or other suitable marking and serves to indicate the location where a roper should place his feet. Roping guide mat 10 is preferably provided in combination with an article of sports equipment (see appendix A—Sports Equipment) such as a roping dummy 20 having a head 22, at least one horn 24, a rear 26, and hind legs 26. Target indicia 14 of roping guide mat 10 may comprise one or more dots, circles, lines, or other suitable marking and serves to indicate the location where the hind legs 26 of roping dummy 20 should be placed. Preferably target indicia 14 defines at least two distinct markings comprising a first target mark and a second target mark. Target indicia 14 indicia may be printed, laminated, or otherwise placed or formed thereon.

In practice, roping guide mat 10 is placed in a flat or unrolled condition on a suitable roping surface such as the ground of a rodeo area. Roping dummy 20 is then positioned over roping guide mat 10 such that a first hind leg 28 of roping dummy 20 is positioned over a first target mark of target indicia 14 and such that a second hind leg 28 of roping dummy 20 is positioned over a second target mark of target indicia 14. A roper then positions his feet on guide indicia 12 of roping guide mat 10. Being so assembled, a roper is properly positioned to engage in roping practice, and more especially to engage in practice of heeling of a roping dummy so as to be better trained to rope an actual animal.

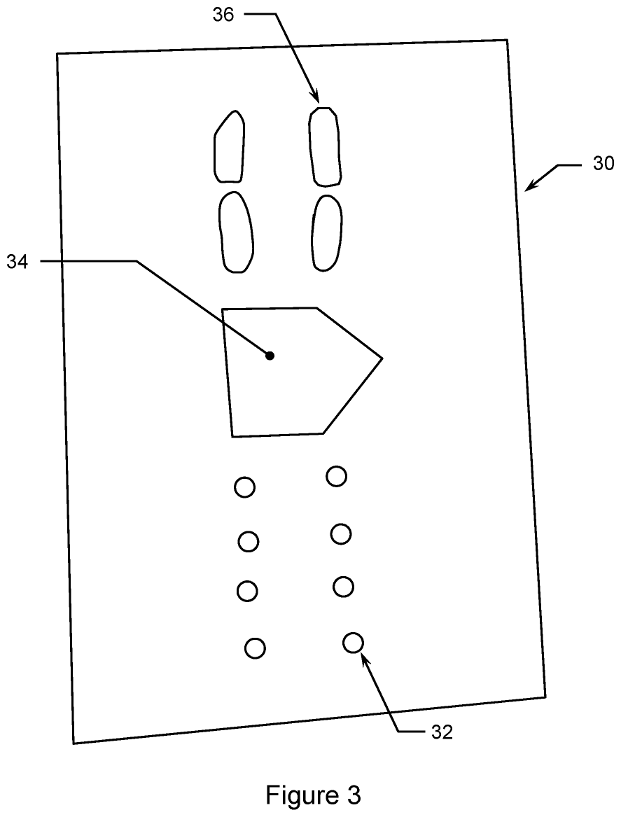

Referring now to the drawings and in particular to FIGS. 3, a second embodiment of the invention is a baseball guide mat 30 having guide indicia 32 thereon adapted to promote the proper positioning of a batter in hitting a baseball. Baseball guide mat 30 preferably defines a mat such as a canvas or plastic mat having dimensions of approximately 4 feet by 6 feet (but may be larger or smaller than 4 feet by 6 feet) and having guide indicia 32 and target indicia 34 thereon. Guide indicia 32 may comprise one or more dots, circles, lines, footprints, or other suitable marking and serves to indicate the location where a batter should place his feet. Footprints 36 specifically illustrate an exemplary form of guide indicia 32. Target indicia 34 preferably comprises the outline of a baseball home base or home plate and serves to indicate the location where a home base would otherwise be located. Target indicia 34 may be printed, laminated, or otherwise placed or formed thereon.

In practice, baseball guide mat 30 is placed in a flat or unrolled condition on a suitable playing surface such as the ground of a baseball diamond. A player such as a batter then positions his feet on guide indicia 32 of baseball guide mat 30 corresponding to the player's dominant hand (e.g. oriented to looking to the outfield, the player stands on guide indicia 32 on the left side of base shaped target indicia 34 if he is right handed and vice versa—see appendix B—How to Layout Homeplate). Being so assembled, a player is properly positioned to engage in batting practice, and more especially to engage in practice of hitting home runs so as to be better trained to hit baseballs in an actual baseball game.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A guide mat apparatus for use in guiding proper positioning of a participant in an activity comprising a guide mat having at least one foot placement indicia and at least one target indicia thereon and at least one article of sports equipment.

2. The apparatus of claim 1, wherein said at least one foot placement indicia defines at least one of a dot, a circle, a line, a footprint, and a combination thereof, and wherein said at least one target indicia defines at least one of a dot, a circle, a line, a set of crosshairs, an outline of a baseball home plate, and a combination thereof

3. The apparatus of claim 1, wherein said at least one article of sports equipment defines a roping dummy.

4. The apparatus of claim 3, wherein said roping dummy includes at least one horn protruding therefrom.

5. The apparatus of claim 1, wherein said at least one target indicia defines a plurality of target indicia, and wherein said at least one article of sports equipment defines a roping dummy having a plurality of hind legs, and wherein said roping dummy is positioned relative to said guide mat such that a first hind leg is positioned proximate a first target indicia and a second hind leg is positioned proximate a second target indicia.

6. The apparatus of claim 5, wherein said roping dummy includes at least one horn protruding therefrom.

7. A guide mat for use in guiding proper positioning of a roper in heading and heeling an animal comprising a mat having at least one foot placement indicia and at least one target indicia thereon, wherein said foot placement indicia indicates proper roper foot placement relative to a roping dummy position, and wherein said at least one target indicia indicates proper roping dummy placement relative to said roper foot placement.

8. The guide mat of claim 7, wherein said at least one foot placement indicia defines at least one of a dot, a circle, a line, a footprint, and a combination thereof, and wherein said at least one target indicia defines at least one of a dot, a circle, a line, a set of crosshairs, and a combination thereof.

9. The guide mat of claim 7, wherein said mat includes at least one article of sports equipment combined therewith.

10. The guide mat of claim 9, wherein said at least one article of sports equipment defines a roping dummy.

11. The guide mat of claim 10, wherein said roping dummy includes at least one horn protruding therefrom.

12. The guide mat of claim 10, wherein said at least one target indicia defines a plurality of target indicia, and wherein said roping dummy includes a plurality of hind legs, and wherein said roping dummy is positioned relative to said guide mat such that a first hind leg is positioned proximate a first target indicia and a second hind leg is positioned proximate a second target indicia.

13. The guide mat of claim 12, wherein said roping dummy includes at least one horn protruding therefrom.

14. A method of using a guide mat apparatus comprising providing a guide mat apparatus comprising a guide mat having at least one foot placement indicia and at least one target indicia thereon and at least one article of sports equipment, and positioning said at least one article of sports equipment in a predetermined position relative to said at least one target indicia.

15. The method of claim 14, wherein said method further includes the step of practicing a sport.

16. The method of claim 14, wherein said at least one article of sports equipment defines a roping dummy.

17. The method of claim 16, wherein said method further includes at least one step of heading said roping dummy and heeling said roping dummy.

18. The method of claim 14, wherein said at least one target indicia defines a plurality of target indicia, and wherein said at least one article of sports equipment defines a roping dummy having a plurality of hind legs and a plurality of horns, and wherein said roping dummy is positioned relative to said guide mat such that a first hind leg is positioned proximate a first target indicia and a second hind leg is positioned proximate a second target indicia.

19. The method of claim 18, wherein said method further includes the step of positioning a foot of a roper on said at least one foot placement indicia.

20. The method of claim 19, wherein said method further includes at least one step of heading said roping dummy and heeling said roping dummy.
